(19) United States
(12) Patent Application Publication
(10) Pub. No.: US 2011/0042469 A1
(43) Pub. Date: Feb. 24, 2011

(54) FURNACE AND CENTRAL COOLING APPARATUS CONFIGURED WITH POWERLINE COMMUNICATION FOR ENERGY MANAGEMENT

(75) Inventors: Tat Keung Chan, Sourth San Francisco, CA (US); Elsa A. Chan, San Francisco, CA (US)

Correspondence Address: AMPACC Law Group, PLLC, 6100 219th Street SW, Suite 580, Mountlake Terrace, WA, 98043, US

(73) Assignee: Jetlun Corporation, South San Francisco, CA (US)

(21) Appl. No.: 12/858,378

(22) Filed: Aug. 17, 2010

Related U.S. Application Data
(60) Provisional application No. 61/234,763, filed on Aug. 18, 2009.

(51) Int. Cl. G05D 23/00

(52) U.S. Cl. 236/51

(57) ABSTRACT

A system for communication between one or more indoor and one or more outdoor units. The system has a furnace apparatus spatially disposed within a building structure. In a specific embodiment, the furnace comprises a furnace control and an energy generation region. The furnace control is configured for at least a first direct current operation. The system also has an air conditioning unit spatially disposed outside of the building structure. The air conditioning unit comprises a compressor device and an air conditioning control configured for at least at least a second direct current operation. The system has a first powerline module configured to communicate with the furnace control and a second powerline module configured to communicate with the air conditioning control. A powerline network is configured to communicate between the first powerline module and the second powerline module.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to energy management techniques. More particularly, the invention provides a method and system for communicating between at least a furnace and an air conditioning apparatus in a building structure using at least power line and other networking techniques, but it would be recognized that the invention has a much broader range of applications. Additionally, the other networking techniques include local area networks such as Ethernet, short range and long range wireless, and other combinations.

### BRIEF SUMMARY OF THE INVENTION

According to the present invention, techniques related generally to energy management are provided. More particularly, the invention provides a method and system for communicating between at least a furnace and an air conditioning apparatus in a building structure using at least power line and other networking techniques, but it would be recognized that the invention has a much broader range of applications. Additionally, the other networking techniques include local area networks such as Ethernet, short range and long range wireless, and other combinations.

In a specific embodiment, the present invention provides a system for communication between one or more indoor and one or more outdoor units. The system has a furnace apparatus spatially disposed within a building structure. In a specific embodiment, the furnace comprises a furnace control and an energy generation region. The furnace control is configured for at least a first direct current operation. The system also has an air conditioning unit spatially disposed outside of the building structure. The air conditioning unit comprises a compressor device and an air conditioning control configured for at least a second direct current operation. The system has a first powerline module configured to communicate with the furnace control and a second powerline module configured to communicate with the air conditioning control. A powerline network is configured to communicate between the first powerline module and the second powerline module.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram of an energy system for communicating between one or more indoor and one or more outdoor apparatus for energy management.

FIG. 2 is a simplified diagram of an alternative energy system for communicating between one or more indoor and one or more outdoor apparatus for energy management.

FIGS. 3 and 4 are simplified diagrams of power line interface and power supply according to embodiments of the present invention.

FIGS. 5 through 7 are simplified block diagrams at least a thermostat (PCT), furnace, A/C, and power line modules/power supplies according to embodiments of the present invention.

### DETAILED DESCRIPTION OF THE INVENTION

According to the present invention, techniques related generally to energy management are provided. More particularly, the invention provides a method and system for communicating between at least a furnace and an air conditioning apparatus in a building structure using at least power line and other networking techniques, but it would be recognized that the invention has a much broader range of applications. Additionally, the other networking techniques include local area networks such as Ethernet, short range and long range wireless, and other combinations.

Since the inception of electricity deregulation and market driven pricing around the world, government regulators have been looking for a means to match consumption with generation. Traditional electrical meters only measure total consumption and as such provide little information of when or how the energy was consumed. Smart meters provide a way of measuring energy consumption in time intervals, allowing price-setting agencies to introduce different prices for consumption based on the time of day and the season.

Electricity pricing usually peaks at certain predictable times of the day and the season. In particular, if generation is constrained, prices can rise significantly during these times as more expensive sources of power are purchased from other jurisdictions or more costly generation is brought online. It is believed that billing customers by how much is consumed and at what time of day will force consumers to adjust their consumption habits to be more responsive to market prices. Regulatory and market design agencies hope these “price signals” will delay the construction of additional generation or at least the purchase of energy from higher priced sources thereby controlling the steady and rapid increase of electricity prices.

With the rising cost of home energy use and the imminent rollout of Time-of-Use (TOU) billing from the power utilities, it has become desirable to know the quantity and the time of use of electrical power consumed by various household appliances so that inefficient uses of electricity can be eliminated and electricity usage can be shifted to off-peak periods. Smart meters in limited usage today provide some solutions to these problems. But even with the new smart meters, it is only provided the total consumption based on the time of day and season. Such smart meters do not provide granular energy usage information that allows a user to pinpoint which device or appliance in the home or office is drawing the most power. This prevents a user from being informed as to which device or appliance can be turned off during peak times when prices are high.

In solving these problems of energy consumption measurement and control, an energy management system (EMS) provides a real-time measurement of the energy consumed by the various electrical loads within the electrical distribution system. With these measurements, a user can pinpoint sources of energy use and remotely control the electrical loads within the electrical distribution system either by turning on or off appliances. Most EMS systems are tailored for industrial commercial loads such as a heating ventilation and air conditioning (HVAC) in a hotel or factory.

Moreover, traditionally network devices often freeze about running for a period of time where the software may lock-up, thereby requiring some physical reset either by turning-on or off the device or unplugging or plugging the device. Since this creates problem for service providers, it would be desirable to provide appropriate solution.

Furthermore, while home automation is greatly appreciated when power is adequate, such is not so during electricity brown or black-out, especially for home automation that is connected to important functions like security systems. Thus it would be desirable as well to provide appropriate solution. These and other limitations of conventional energy monitoring techniques are overcome by the present method and systems according to one or more embodiments.

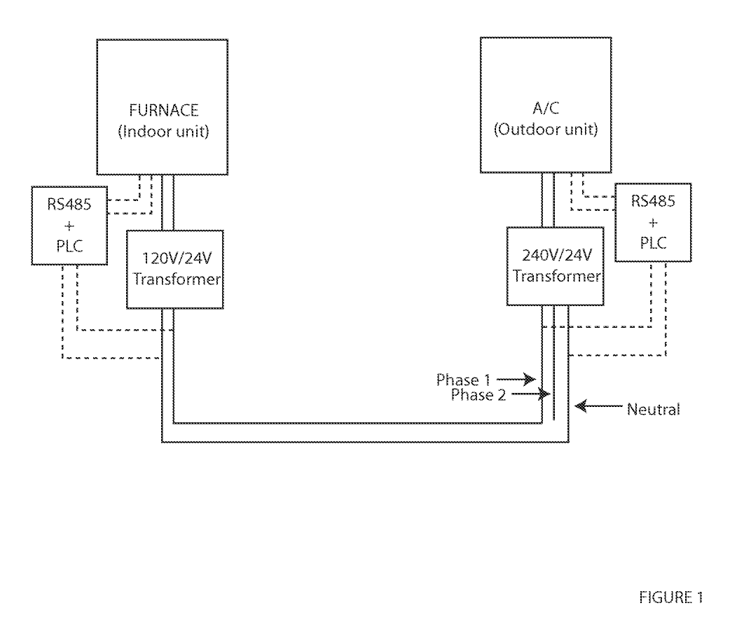

FIG. 1 is a simplified diagram of an energy system for communicating between one or more indoor and one or more outdoor apparatus for energy management. This diagram is merely an example, which should not unduly limit the claims herein. One of ordinary skill in the art would recognize many other variations, modifications, and alternatives. As shown, the energy system for communication between one or more indoor and one or more outdoor units is provided. The system also has a furnace apparatus spatially disposed within a building structure. In a specific embodiment, the furnace apparatus is within a basement region or other interior region of the building structure. In a specific embodiment, the furnace apparatus comprises a furnace control and an energy generation region. In a specific embodiment, the furnace control is configured for at least a first direct current operation. In a specific embodiment, the system also has an air conditioning unit spatially disposed outside of the building structure or partially disposed within the building structure. Again, there could be other variations, modifications, and alternatives. In a specific embodiment, the air conditioning unit comprises a compressor device and an air conditioning control configured for at least a second direct current operation. Further details of the present system can be found throughout the present specification and more particularly below.

In a specific embodiment, the system is configured with powerline modules coupled to one or more powerlines to form a powerline network. In a specific embodiment, the system includes a first powerline module configured to communicate with the furnace control. The system also has a second powerline module configured to communicate with the air conditioning control according to one or more embodiments. The system has a powerline network configured to communicate between the first powerline module and the second powerline module. Of course, there can be other variations, modifications, and alternatives.

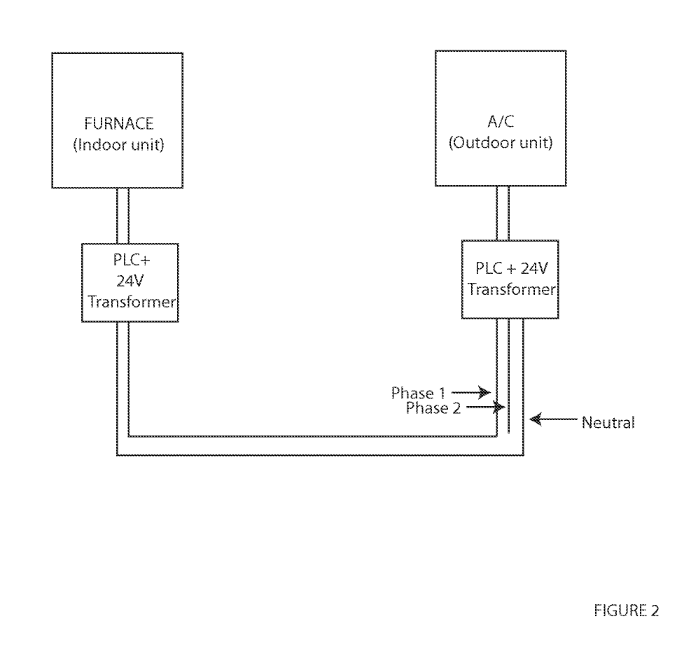

In yet an alternative embodiment, FIG. 2 is a simplified diagram of an alternative energy system for communicating between one or more indoor and one or more outdoor apparatus for energy management. This diagram is merely an example, which should not unduly limit the claims herein. One of ordinary skill in the art would recognize many other variations, modifications, and alternatives. As shown, the energy system for communication between one or more indoor and one or more outdoor units is provided. The system also has a furnace apparatus spatially disposed within a building structure. In a specific embodiment, the furnace apparatus is within a basement region or other interior region of the building structure. In a specific embodiment, the furnace apparatus comprises a furnace control and an energy generation region. In a specific embodiment, the furnace control is configured for at least a first direct current operation. In a specific embodiment, the system also has an air conditioning unit spatially disposed outside of the building structure or partially disposed within the building structure. Again, there could be other variations, modifications, and alternatives. In a specific embodiment, the air conditioning unit comprises a compressor device and an air conditioning control configured for at least a second direct current operation. Further details of the present system can be found throughout the present specification and more particularly below.

In a specific embodiment, the system is configured with powerline modules coupled to one or more powerlines to form a powerline network. In a specific embodiment, the system includes a first powerline module configured to communicate with the furnace control. The system also has a second powerline module configured to communicate with the air conditioning control according to one or more embodiments. The system has a powerline network configured to communicate between the first powerline module and the second powerline module. In a preferred embodiment, each of the powerline modules is configured within its power transformer, as shown, to form a single integrated unit for efficiency. Of course, there can be other variations, modifications, and alternatives.

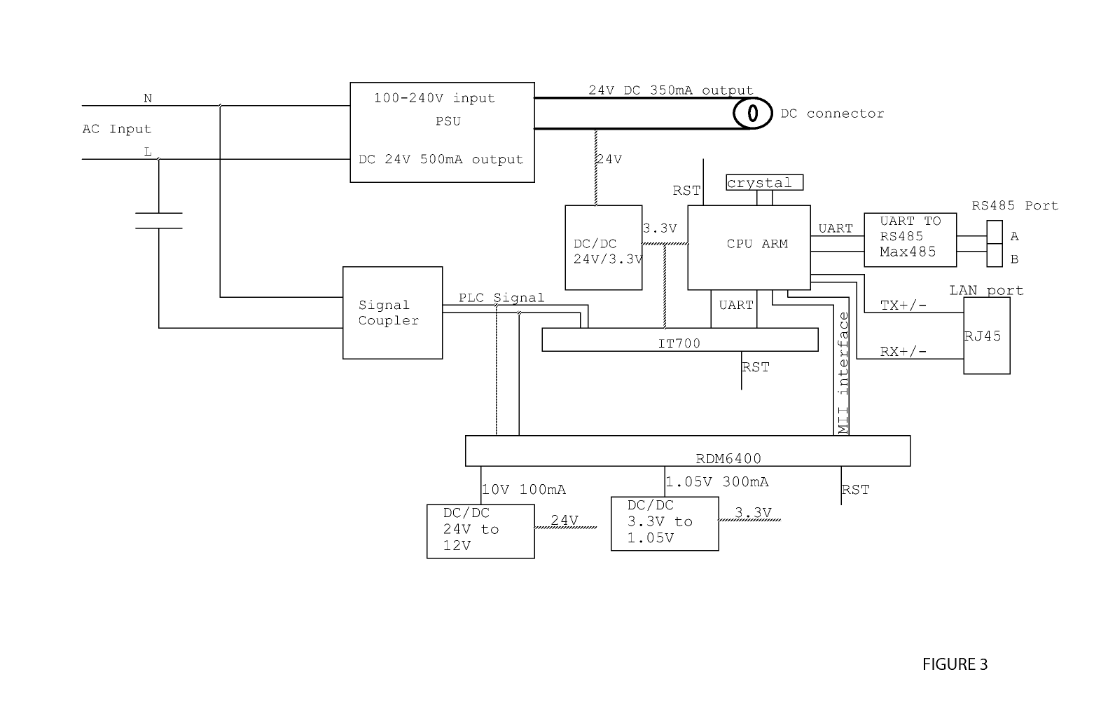

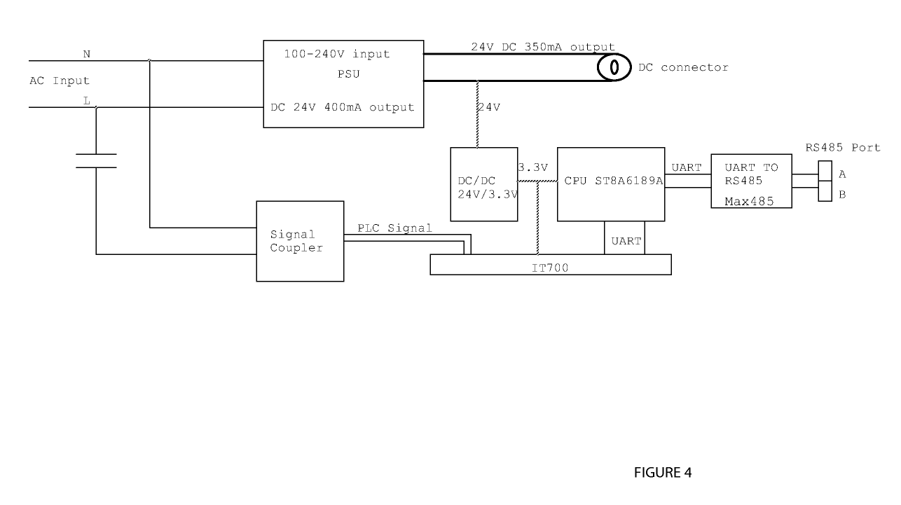

FIGS. 3 and 4 are simplified diagrams of power line interface and power supply according to embodiments of the present invention. These diagrams are merely examples, which should not unduly limit the scope of the claims herein. One of ordinary skill in the art would recognize other variations, modifications, and alternatives.

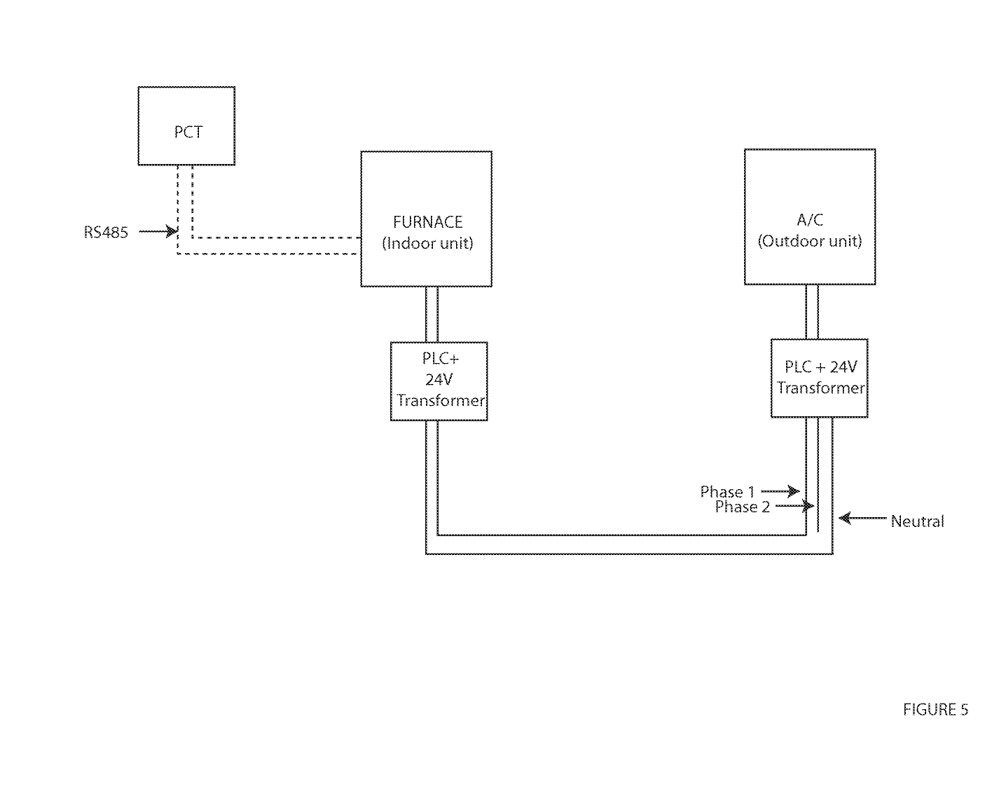

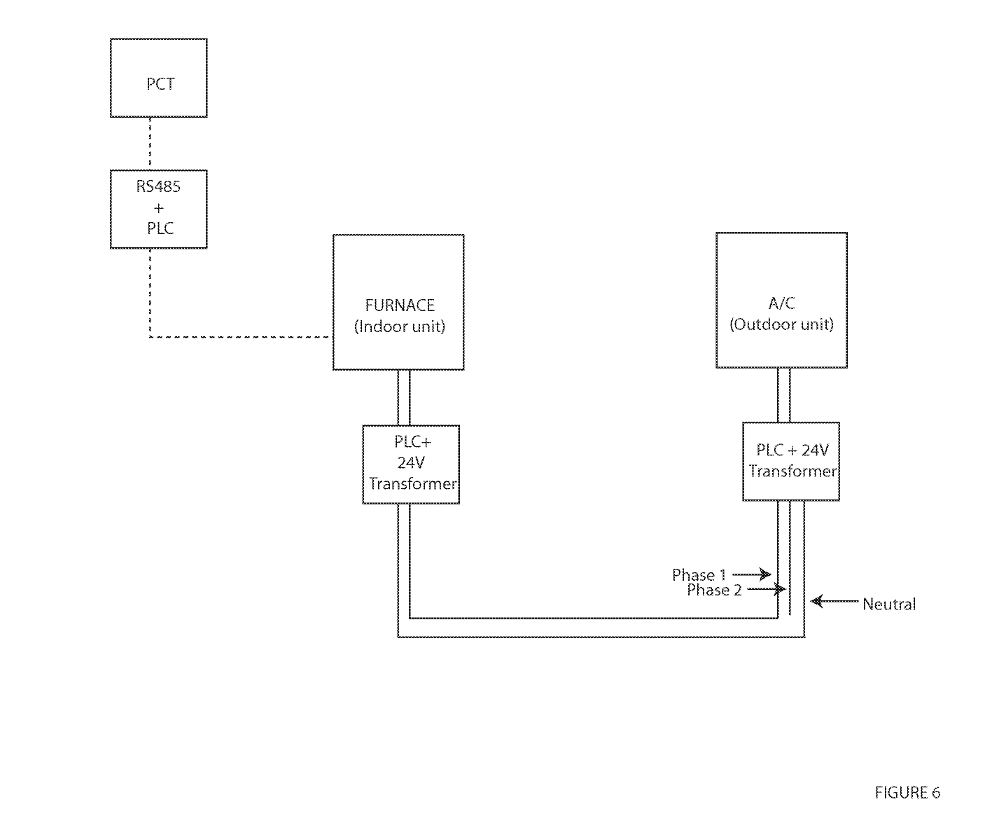

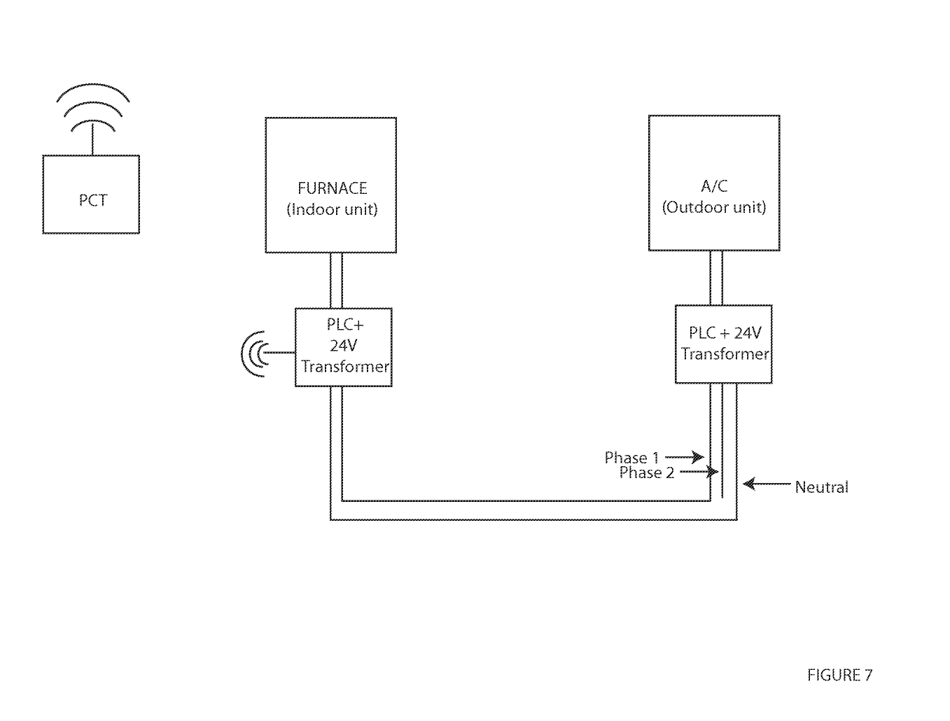

FIGS. 5 through 7 are simplified block diagrams at least a thermostat (PCT), furnace, A/C, and power line modules/power supplies according to embodiments of the present invention. These diagrams are merely examples, which should not unduly limit the scope of the claims herein. One of ordinary skill in the art would recognize other variations, modifications, and alternatives.

While the above is a full description of the specific embodiments, various modifications, alternative constructions and equivalents may be used. As an example, the packaged device can include any combination of elements described above, as well as outside of the present specification. Of course, there can be other variations, modifications, and alternatives. Therefore, the above description and illustrations should not be taken as limiting the scope of the present invention which is defined by the appended claims.

What is claimed is:

1. A system for communication between one or more indoor and one or more outdoor units, the system comprising:
a furnace apparatus spatially disposed within a building structure, the furnace comprising a furnace control and an energy generation region, the furnace control being configured for at least a first direct current operation;
an air conditioning unit spatially disposed outside of the building structure, the air conditioning unit comprising a compressor device and an air conditioning control configured for at least a second direct current operation;
a first powerline module configured to communicate with the furnace control;
a second powerline module configured to communicate with the air conditioning control; and
a powerline network configured to communicate between the first powerline module and the second powerline module.

2. The system of claim 1 wherein the first powerline module is configured for the first direct current operation.

3. The system of claim 1 wherein the second powerline module is configured for the second direct current operation.

4. The system of claim 1 wherein the powerline network comprises one or more powerline cables routed through the building structure.

5. The system of claim 1 wherein the furnace apparatus is spatially disposed within a basement region of the building structure.

6. The system of claim 1 wherein the air conditioning unit is spatially disposed partially within the building structure.

7. The system of claim 1 wherein the first powerline module comprises a powerline integrated circuit coupled to an analog front end.

8. The system of claim 1 wherein the second powerline module comprises a powerline integrated circuit coupled to an analog front end.

9. The system of claim 1 wherein the first powerline module comprises a first powerline signal configured to coupled to a first phase and a second phase.

10. The system of claim 1 wherein the second powerline module comprises a second powerline signal configured to coupled to a first phase and a second phase.

11. The system of claim 1 wherein the first direct current operation is 24 volts.

12. The system of claim 1 wherein the second direct current operation is 12 volts.

13. The system of claim 1 wherein the powerline network is configured for 240 volts AC.

14. The system of claim 1 wherein the powerline network is configured for 120 volts AC.
